(19) United States
(12) Patent Application Publication
(10) Pub. No.: US 2015/0217698 A1
(43) Pub. Date: Aug. 6, 2015

(54) VEHICLE RACK

(71) Applicant: Jason Evans, Waterloo, IA (US)

(72) Inventor: Jason Evans, Waterloo, IA (US)

(21) Appl. No.: 14/608,367

(22) Filed: Jan. 29, 2015

Related U.S. Application Data
(60) Provisional application No. 61/933,023, filed on Jan. 29, 2014.

(51) Int. Cl. B60R 9/052; B60R 9/10; B60R 9/045

(52) U.S. Cl. CPC B60R 9/052; B60R 9/045; B60R 9/10

(57) ABSTRACT

The present disclosure relates to a rack for securing objects to a vehicle for automotive transportation. The rack includes at least one horizontal mounting bar, wherein each horizontal mounting bar may be deconstructed into multiple sections, at least two vertical towers, wherein each vertical tower includes an opening through which a horizontal mounting bar may be positioned, and attachment devices which attach the vertical towers to the vehicle. Shoulder bolts may be used in the vertical towers, such that the horizontal mounting bars may pivot when attached to the vertical towers. Bar connectors may be used to add horizontal mounting bars to change the shape of the rack. Safety straps and safety strap holders may be used in addition to the attachment devices to secure the rack to the vehicle. A bicycle wheel mount may be used to store a front bicycle tire on the bicycle during vehicle transportation.

### FIELD OF THE INVENTION

The present disclosure relates to apparatuses and methods for securing objects for automotive transportation. Particularly, the present disclosure relates to a rack that is attached to an automobile so that objects may be secured to the rack during automotive transportation. More particularly, the present disclosure relates to a rack consisting of horizontal mounting bars, vertical towers, and attachment devices, and that may be disassembled into smaller components for ease of use and storage.

### BACKGROUND

Bike racks and other types of roof racks often include crossbars that bikes or other items may be secured to for transportation. The crossbars are often bulky horizontal bars that may not be easily stored when not in use. Some other racks include large, flat surfaces for attaching to the roof or rear of a vehicle. In many cases, the racks may not be suitable for mounting on vehicles with rounded body styles or small surfaces and in some cases, the racks may lack versatility by being designed to transport particular items, such as bicycles.

In still other cases, racks may simply lack convenience. For example, some racks may be designed for use by removing the front tire of the bicycle and attaching the front fork directly to the rack. These racks often do not incorporate a system to store the detached front bicycle tire during automotive transportation. Users are left to store the front bicycle tire in the trunk, bed, or cabin of the vehicle.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, relates to a rack for securing objects for automotive transportation. The rack includes at least one horizontal mounting bar, at least two vertical towers, wherein each vertical tower includes a pivoting mechanism to allow for varied placement of the towers, and attachment devices which attach the vertical towers to the automobile. Safety straps may be used in addition to the attachment devices to secure the rack to the vehicle. Safety strap holders may be used to attach the safety straps to the horizontal mounting bars. In some embodiments, each horizontal mounting bar may be deconstructed into multiple sections. In some embodiments, a bicycle wheel mount may be used to attach a disconnected bicycle tire to a bicycle frame during automotive transportation.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a perspective view of a rack installed on a car, according to some embodiments.

FIG. 2 is an exploded view of a vertical tower and coupling mechanism of the rack of FIG. 1.

FIG. 3 includes a top, side, and perspective of the vertical tower of FIG. 2.

FIG. 4 includes a side, front, and perspective view of the coupling mechanism of FIG. 2.

FIG. 5 is a perspective view of a safety strap and safety strap holder, according to some embodiments.

FIG. 6 includes a top, side, and perspective view of one embodiment of the safety strap holder of FIG. 5.

FIG. 7 includes a perspective and side views a bar connecter, according to some embodiments.

FIG. 8 includes bottom, side, and front views of one embodiment of a bicycle wheel mount of the present disclosure.

FIG. 9 shows one embodiment of a bicycle wheel mount of the present disclosure.

FIG. 10 shows a horizontal mounting bar disassembled into multiple pieces, according to some embodiments.

FIG. 11 shows a horizontal mounting bar after the multiple pieces of FIG. 10 are assembled.

FIG. 12 shows a rack secured to the rear window of a pickup truck, according to some embodiments.

FIG. 13 shows a close-up view of the rack of FIG. 12.

FIG. 14 is a perspective view of the rack of FIG. 1 installed on a truck, according to some embodiments.

### DETAILED DESCRIPTION

The present disclosure, in some embodiments, relates to a roof rack for attaching to a vehicle, such as a car, truck, van, or sport utility vehicle. The rack may include horizontal mounting bars for supporting bikes, canoes, or other items and the bars may be breakable into a smaller more compact arrangement when not in use. The bars may be supported by towers configured to extend generally perpendicularly to a roof surface and the towers may accommodate all types of roof arrangements including very barrel-shaped roofs. That is, for example, where the towers are radiating somewhat radially from a barrel-shaped roof, a horizontally extending bar may be readily secured to the tower without shimming or otherwise adjusting the vertical angle of the tower. In still other embodiments, a wheel mount may be provided for securing a front wheel of a bike to an alternative location on the bike when transporting fork-mounted bicycles.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

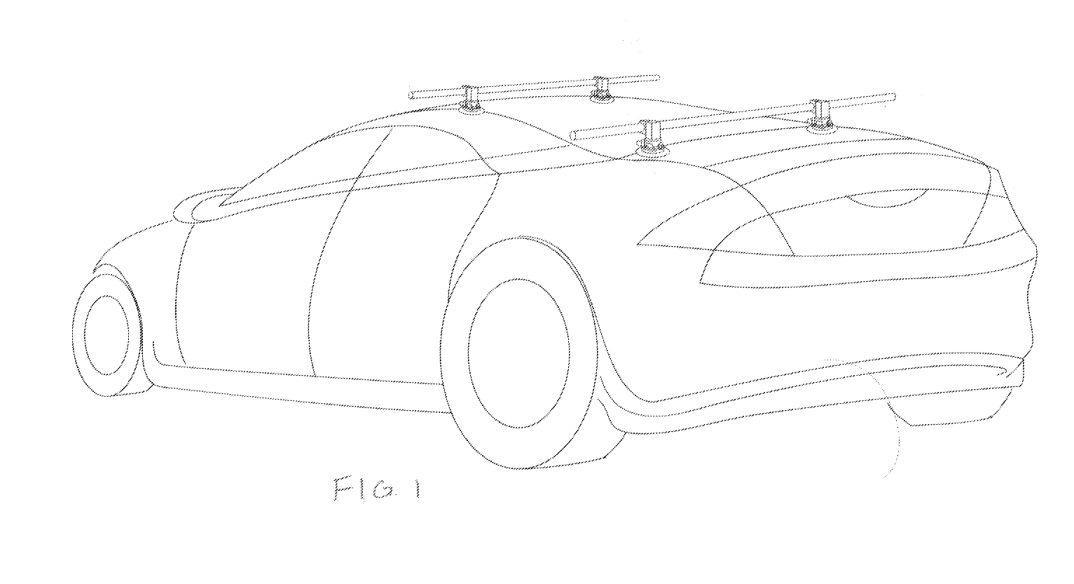

FIG. 1 depicts one embodiment of a rack of the present disclosure. The rack may be configured for securing to a vehicle and for supporting items for transportation such as bicycles, canoes, skis, and other recreational or other items that are not convenient to place within a vehicle. As shown in FIG. 1, the rack may include a horizontal mounting bar; vertical towers; bar holders that couple the horizontal bars to the vertical towers; attachment devices that attach the vertical towers to the vehicle; and safety strap systems, which may help to secure the rack to the vehicle. Each of these particular element are described in more detail below.

In one embodiment of the present disclosure, as shown in FIG. 1, the horizontal mounting bars may have a round cross section. In other embodiments, the bars may have an oval, square, rectangular, triangular, polygonal, or other cross section shape. The diameter of each horizontal mounting bar may range from one half inch to four inches. The bars may range in length from six inches to eight feet. Still other diameters and lengths of the bars may be provided. The horizontal mounting bars may be composed of rigid plastic, steel, carbon steel, titanium, or any other metal, metal alloy, or rigid material. In one embodiment, horizontal mounting bars may be composed of carbon fiber.

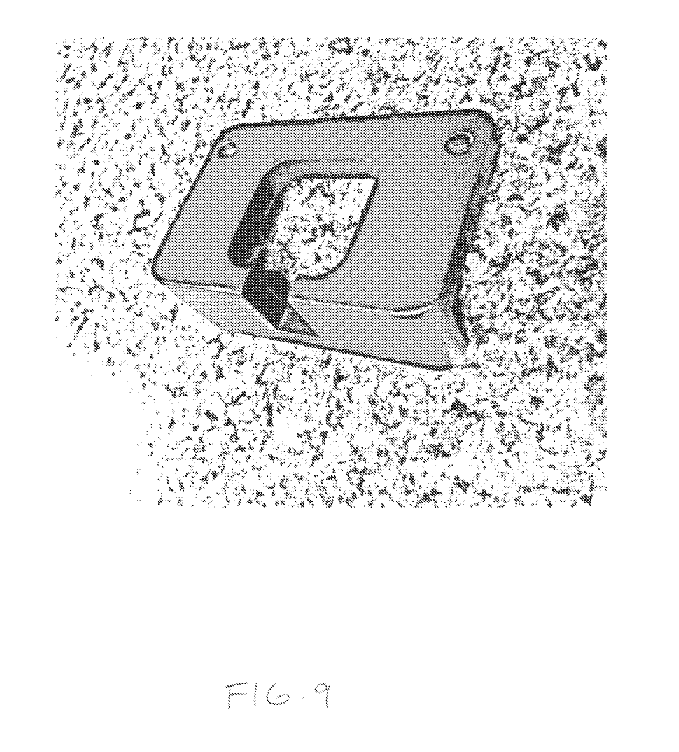

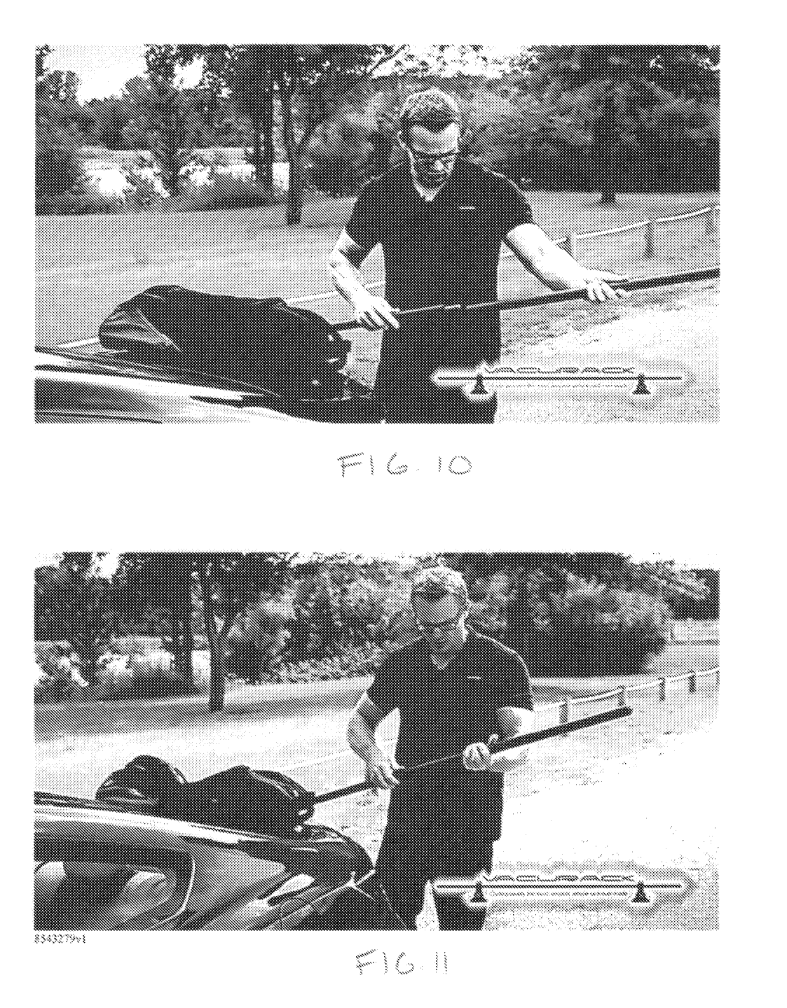

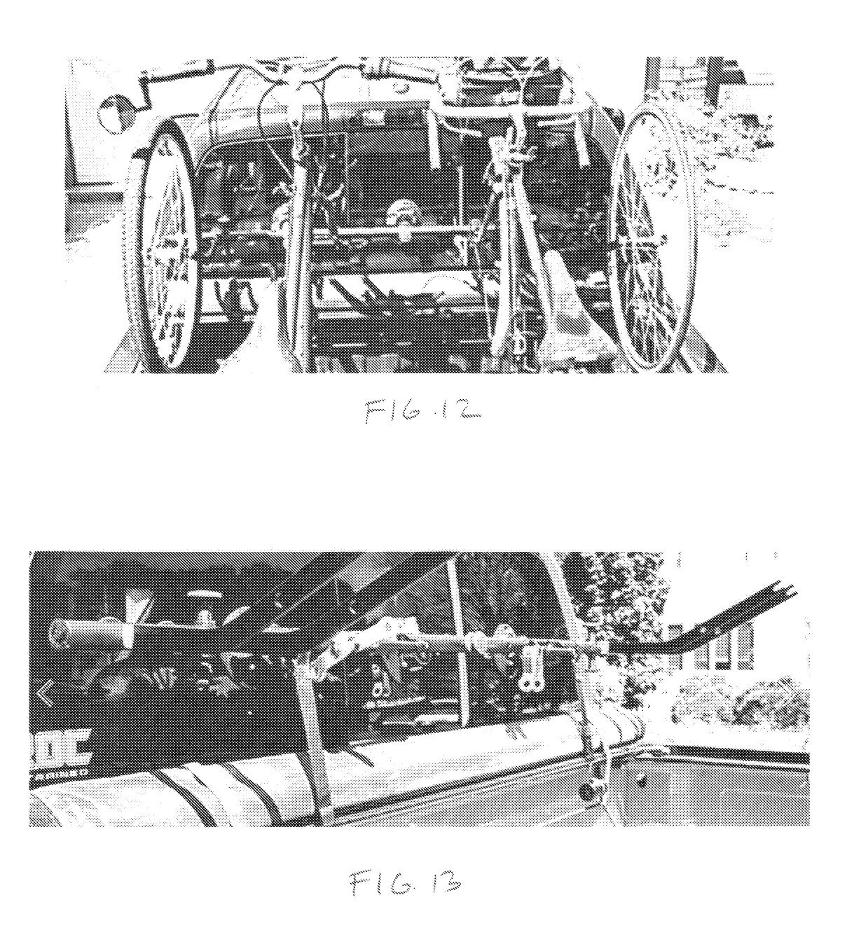

In some embodiments, the horizontal mounting bar may be disassembled into multiple sections. In one embodiment, as shown in FIG. 10, this may be accomplished through the use of threading at each end of sectioned pieces of a horizontal mounting bar. For example, one section of the mounting bar may have threading on the outside of one end of the section and that end may be slightly narrower than the rest of the bar. The other section of the mounting bar may be hollow or have a bore extending into an end thereof. The hollow section or the bore may have threading on the inside surface thereof. Thus, when one end with outside threading of one section and one end with inside threading of another section are threaded together, the two pieces may combine to form a longer section of the mounting bar. In some embodiments, sections with inside or outside threading may be provided on more than one end of the sections such that multiple sections (i.e., more than two) may be strung together to create a bar. End sections of the bar may have threading on a single end and the other end may be capped such that clean ends may be provided on the bar. In other embodiments, threading may be provided on the ends of the bars. Still other arrangements of threading may be provided.

In another embodiment of the present disclosure, disassembled sections of the horizontal mounting bars may be attached to one another using a spring ball connection. For example, one section of the mounting bar may have a spring ball at one end and that end may be slightly narrower than the rest of the mounting bar. The other section of the bar may have a small hole through which a the spring ball may fit located at one end of the section. Thus, when the narrower end of one section is placed inside the end of the other section, the spring ball may lock into the hole to secure the two sections into a longer section of the mounting bar. Like the threaded embodiment, the ends opposite the spring ball connection/hole may be capped for a clean end or each end of the sections may have spring ball and/or holes for stringing multiple sections together. In other embodiments, other methods, such as a lever lock, screw, or bolt, may be used to attach the disassembled sections of the horizontal mounting bars together.

Each horizontal mounting bar may be disassembled into two or more sections using one or more of the above methods. The length of each section may depend upon the desired length of the assembled mounting bar and the number of sections into which the bar disassembles. As mentioned above, in one embodiment, two of the mounting bar sections may be designated as end sections, and therefore may not be hollowed or have threading, a spring and ball plunger, or any other attachment mechanism on one end. These two sections may form the ends of the completed horizontal mounting bar.

In one embodiment of the present disclosure, each horizontal mounting bar may be coupled to vertical towers, which are in turn attached to the vehicle with attachment devices. In some embodiments, vertical towers may range in height from one to eight inches. Other heights within this range or outside this range may also be provided. The vertical towers may have a square, round, oval, rectangular, triangular, polygonal, or other cross-sectional shape. In one embodiment, the vertical towers may have an “L” or angle iron shape. The vertical towers may be composed of rigid plastic, steel, carbon steel, or any other metal, metal alloy, or rigid material. Still other materials may also be provided. The vertical towers may include a base portion for interfacing with an attachment device and the tower may extend from the base portion and have a coupling portion for securement of a coupling device. The base portion and coupling portion may each include a bore, threaded bore, slot, or other feature for securing the tower to the attachment device and for securing the coupling device to the tower.

In some embodiments, the vertical towers may incorporate threading, which may allow the height of the towers to be adjusted. In other embodiments, other adjustment measures may be used, such as spring and ball plungers. In either case, for example, the towers may have a foot or other telescoping or adjustable portion that is extendable out the bottom of the tower such that the length/height of the tower can be adjusted using the adjustment mechanisms mentioned.

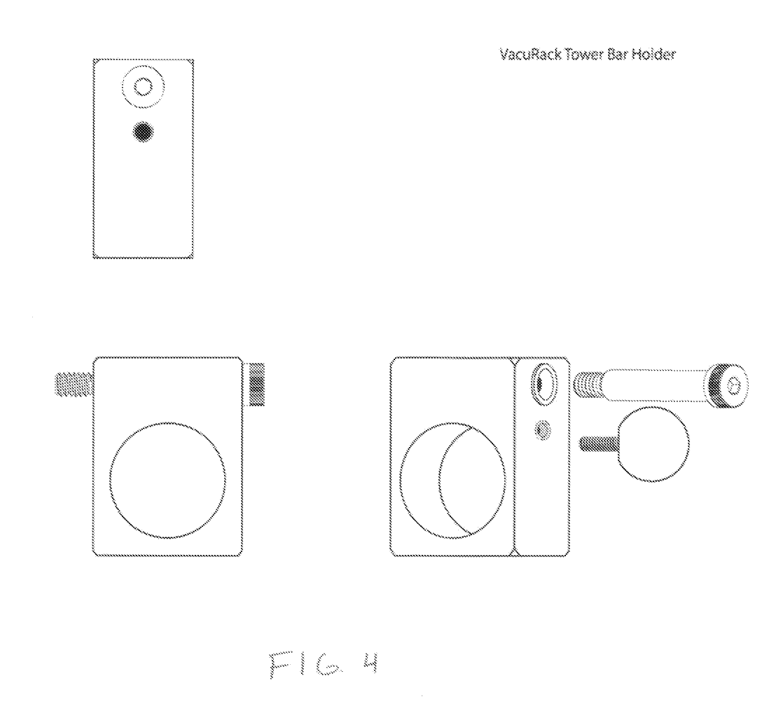

A coupling device may be secured to or arranged on the tower. For example, the coupling device may be located near one end of each tower allowing the horizontal mounting bars to be connected to the vertical towers. In one embodiment of the present disclosure, as shown in FIG. 4, the coupling device may be a rectangular component composed of rigid plastic, steel, carbon steel, or any other metal, metal alloy, or rigid material, with an opening through which a horizontal mounting bar may be positioned. The opening may have a round cross-section or other cross-section sized and arranged to receive the cross-bar. While the cross-section may be the same shape as the bar, other shapes may be provided if sized large enough to allow the crossbar to pass therethrough. In other embodiments, the coupling device may be any other shape, including, but not limited to, circular, triangular, square, or polygonal.

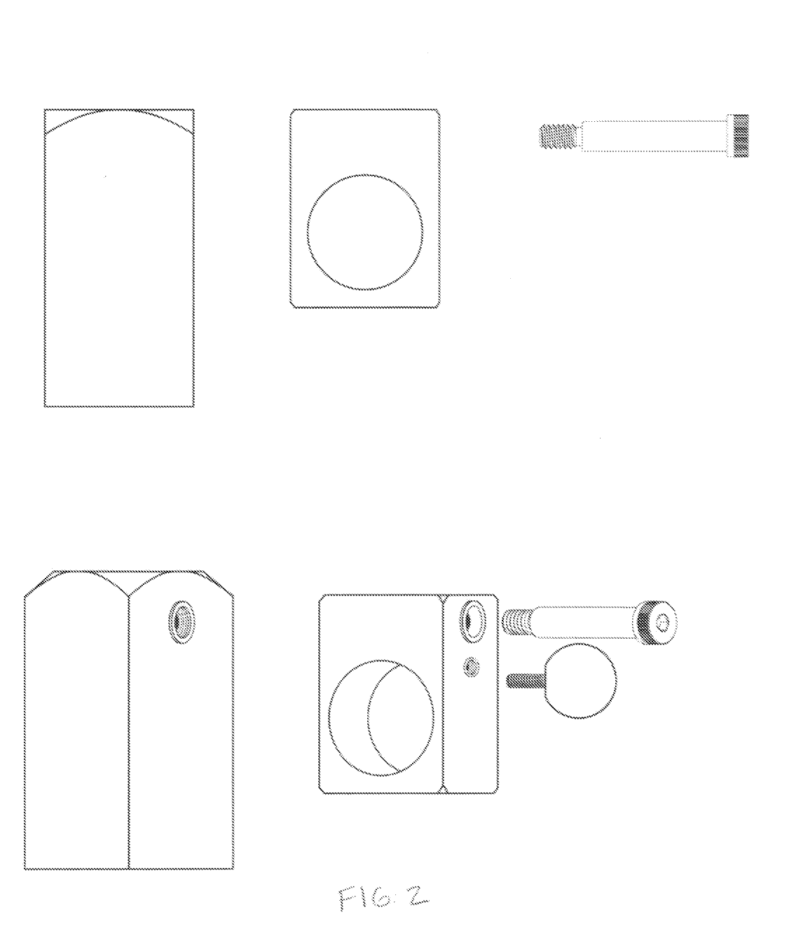

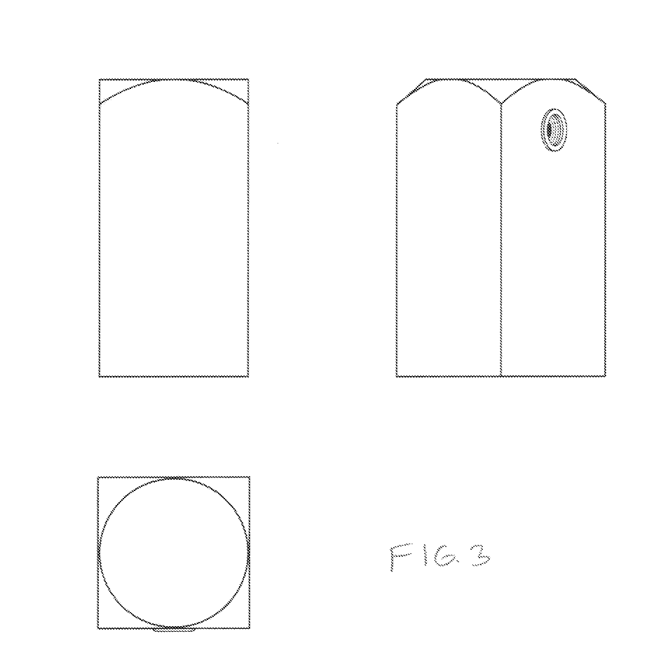

A coupling device may be attached to a vertical tower with a screw, bolt, or other fastening device. In one embodiment, as shown in FIG. 2, a shoulder bolt may be used to attach a coupling device to a vertical tower. Use of a shoulder bolt may allow the coupling device to pivot about the shoulder bolt when it is attached. In other embodiments, a different pivoting method may be used, such as a ball and socket or other device. In other embodiments, the coupling device may be molded with the vertical tower as one piece or as a moveable piece within the tower, with no fastening device necessary, such that the horizontal mounting bar passes directly through the vertical tower structure or through the moveable piece within the tower.

In one embodiment, the opening through which the horizontal mounting bar is placed may be slightly larger than the horizontal mounting bar. A lock screw may be placed perpendicular to the hole through which the horizontal mounting bar is placed. The lock screw, when tightened, may pass through to the opening for the horizontal mounting bar. This lock screw may be used to hold the horizontal mounting bar in place and prevent movement when the bar is positioned in the opening.

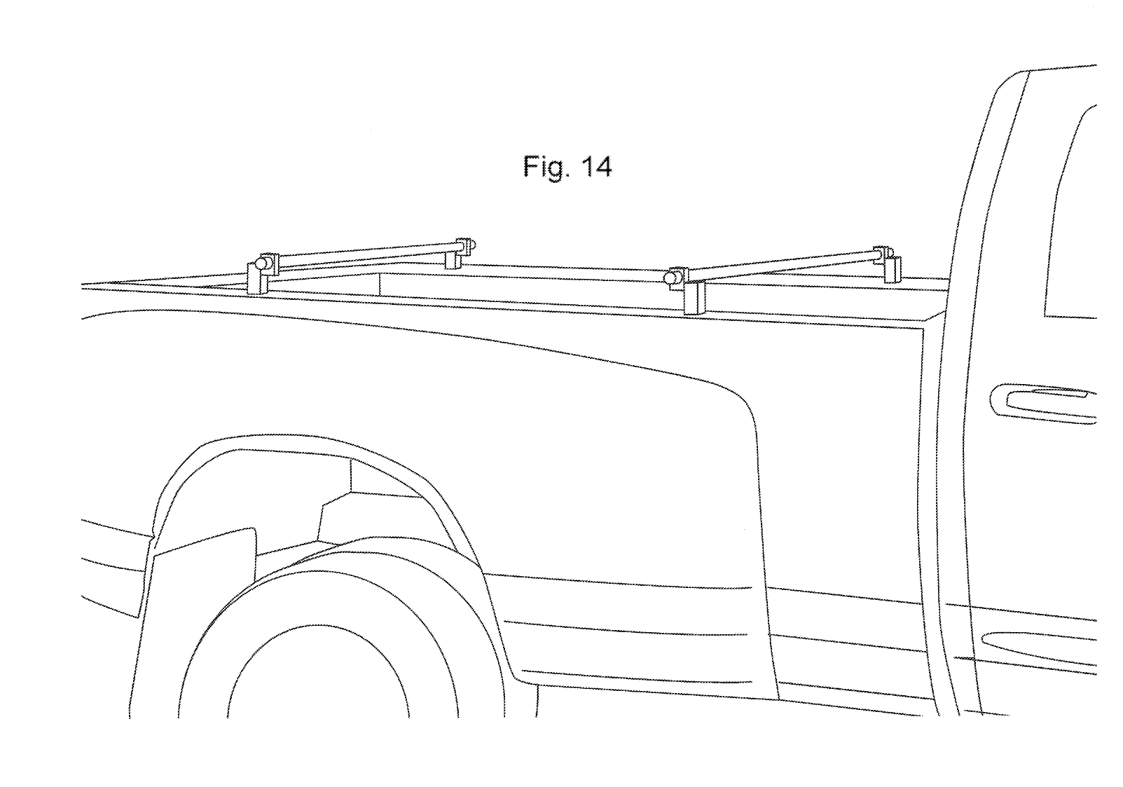

An attachment device may connect each vertical tower to the roof or rear of a vehicle. In one embodiment, this attachment device may be a suction or vacuum cup at one end of each vertical tower, as shown in FIG. 1. In other embodiments, the attachment device may be a different form of attachment such as an adhesive or clamp. In further embodiments, the attachment device may be a bolt or screw, as shown in FIG. 14, where, for example, the towers are secured to the rails of a pickup truck by bolting through the rails.

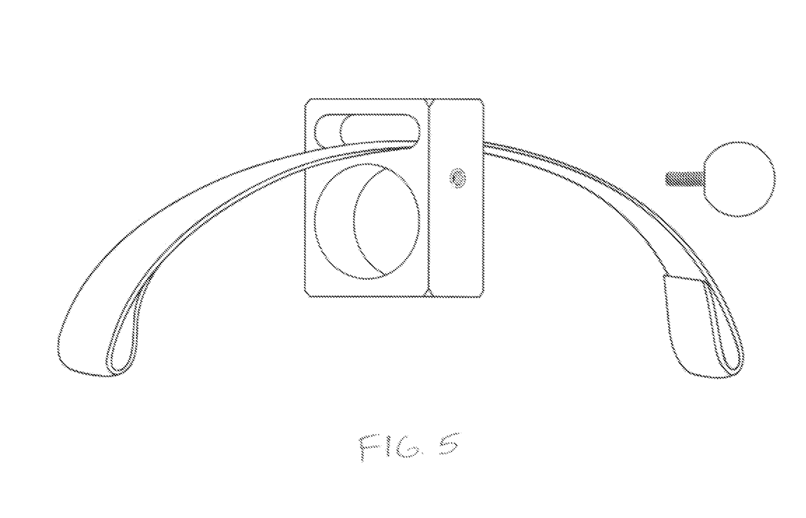

In one embodiment of the present disclosure, in addition to the attachment devices described above, each vertical tower may also be secured to the vehicle using a safety strap and safety strap holder, as shown in FIG. 5. The safety strap may be composed of nylon or another durable fabric. A loop with a diameter slightly larger than the horizontal mounting bar may be located at one end of the safety strap, such that the loop may be placed over a horizontal mounting bar before the safety strap holder is placed on the bar. The opposite end of the safety strap may be threaded through the safety strap holder and placed between one of the vehicle doors and the vehicle body, such that when the vehicle door is closed, the safety strap is clamped between the door and vehicle body. In some embodiments, the safety strap may include a weight on one end so as to draw the safety strap into the door opening and drawing the strap taut as the door is closed.

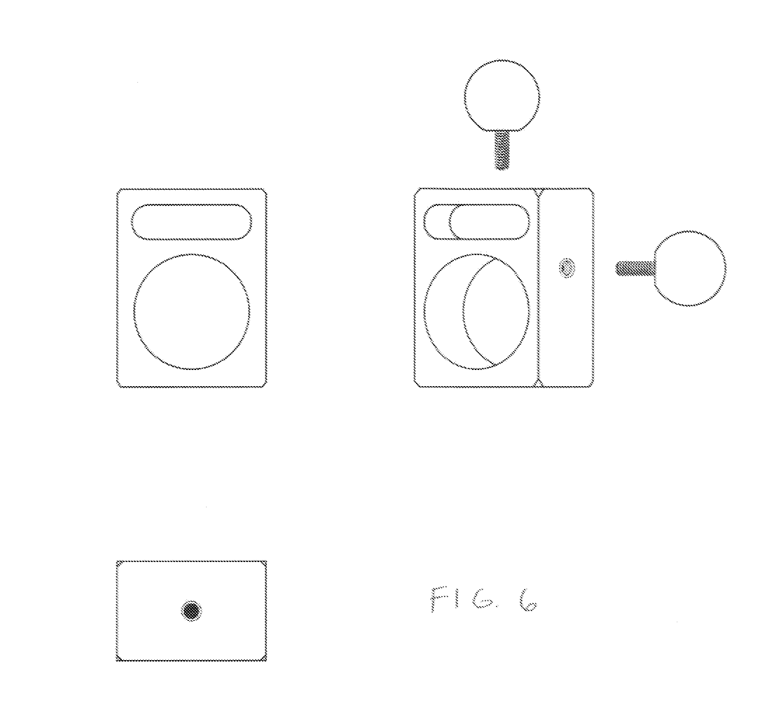

In one embodiment, the safety strap holder may be a rectangular component with one opening through which a horizontal mounting bar may be passed, thus allowing the safety strap holder to be positioned on the horizontal mounting bar, and a second opening through which the safety strap may be placed. The safety strap holder may be locked in position on the horizontal mounting bar through the use of a lock screw, positioned perpendicular to the opening for the horizontal mounting bar. A second lock screw may be used perpendicular to the opening for the safety strap holder in order to lock the safety strap in place, as shown in FIG. 6. The safety strap holder may be composed of rigid plastic, steel, carbon steel, or any other metal, metal alloy, or rigid material.

In other embodiments, the strap may include a loop for slipping over the horizontal bar prior to placing the bar in the coupling device. The loop may be sized to be large enough to slip over the bar but not large enough to fit over the coupling device and tower assembly. Once the tower is secured, the loop may be slipped over the bar on an inner side of the tower and the bar may be placed through the coupling device and secured. The opposite end of the strap may then be placed into a car door opening and secured by closing the door.

In one embodiment of the present disclosure, a bar connector may be used to connect horizontal mounting bars to each other. One embodiment of a bar connector of the present disclosure is shown in FIG. 7. In one embodiment, a bar connector may be a rectangular component with two openings through which horizontal mounting bars may be positioned. In other embodiments, the bar connector may be square, triangular, round, or any other shape. The two openings for horizontal mounting bars may be perpendicular, such that when a horizontal mounting bar is positioned through each opening, the two horizontal mounting bars are positioned perpendicular to each other. The openings for the horizontal mounting bars may be separated vertically, such that when horizontal mounting bars are passed through each opening, the bars will not collide or intersect. A lock screw may be used perpendicular to each opening to lock each horizontal mounting bar in place when it is positioned through the opening. The bar connector may allow an additional bar to be used to secure or tie the a front and back bar together, for example. In some embodiment, a single additional bar may be positioned along the centerline of a vehicle, for example, extending from a back bar to a front bar and secured to each bar with a bar connector. In other embodiments two additional bars may be provided along each side of the rack or multiple additional bars may be used.

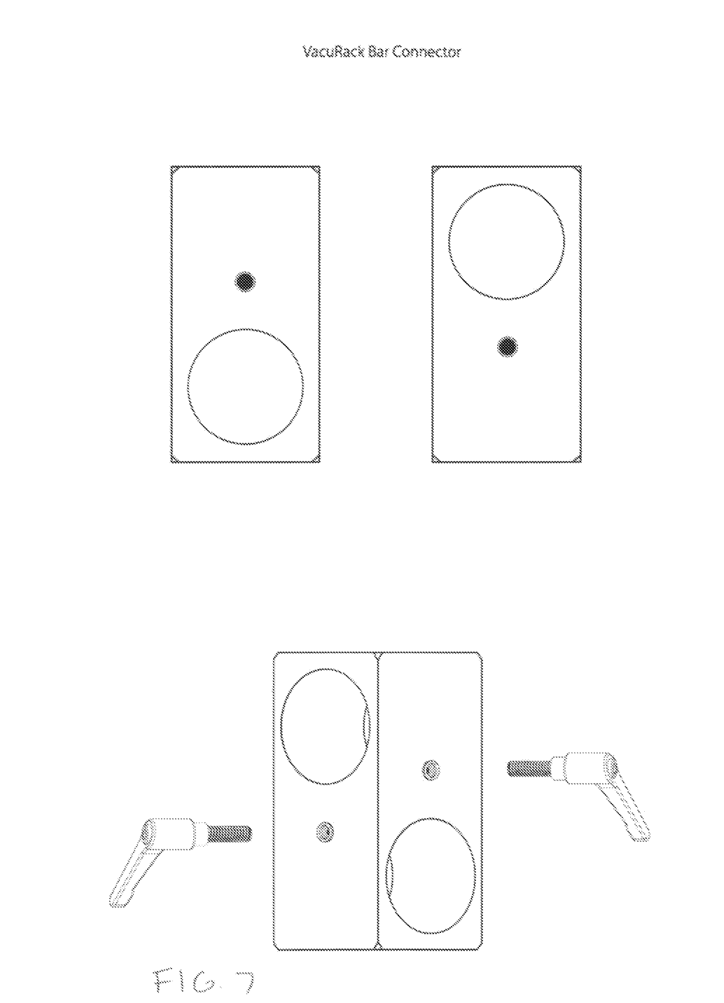

In one embodiment of the present disclosure, a bicycle wheel mount may be used to hold the front tire of a bicycle while the bicycle is mounted to the rack of the present disclosure. One embodiment of a bicycle wheel mount is shown in FIG. 8. A bicycle wheel mount may be attached to the seat post of a bicycle, the lower cross bar of a bicycle, the upper cross bar of a bicycle, or any other bar on a bicycle. The seat post embodiment has that advantage that many bicycles are manufactured for use with an industry standard sized seat post. A bicycle wheel mount may include an opening or recess together with a slot to which the axle of a bicycle tire may be secured. For example, the slot may resemble the notch in the front fork of a bicycle that rests on the axle of the bicycle tire, but the slot in the mount may be arranged with its open side facing upward so as to support the axle rather than be supported by the axle. The wheel mount may be particularly adapted to receive an axle of a wheel having a quick-release assembly on it allowing the tire to be quickly and easily secured to the wheel mount just as it is quickly and easily secured to the fork of the bicycle.

The bicycle wheel holder may be connected to the bicycle through the use of bolts, screws, clamps, or other attachment devices. In one embodiment, the bicycle wheel holder may be attached to the bicycle using a threaded clamp, such as that shown in FIG. 8, which may be tightened against the bicycle to hold the bicycle wheel mount in place. Use of the bicycle wheel mount allows the front wheel of a bicycle to be located and transported on the rack along with the bicycle for those bicycles that may be attached to the rack using a front fork-mounted method. This wheel mount may reduce or eliminate the need to store the front tire of a fork-mounted bicycle within the vehicle cabin, trunk, or bed.

In one embodiment, as shown in FIG. 8, the bicycle wheel mount may include a rectangular-shaped component. In other embodiments, the wheel mount may be any other shape, including circular, square, or oval. It may include a square or rectangular-shaped opening or recess together with a square or rectangular-shaped slot to which the axle of a bicycle tire may be secured. The slot may be shaped or cut to resemble the notch in the front fork of a bicycle that rests on the axle of the bicycle tire. In other embodiments, the opening or recess and the slot may be cut or formed into any other shape, such as circular. The opening or recess may be located on one side of the component, and the slot may be located on a perpendicular surface. The slot and opening or recess may be positioned so that they intersect or join at a 90° angle, thereby allowing the end of bicycle tire axle to be placed through the slot and into the opening or recess. In other embodiments, the opening or recess and the slot may be shaped and located in any other arrangement in order to receive a bicycle tire axle. The wheel mount may include a second opening, sized large enough such that the seat post of a bicycle seat may be passed through the opening, thus allowing the wheel mount to be positioned on the bicycle beneath the bicycle seat. A bicycle wheel mount may be composed of rigid plastic, steel, carbon steel, or any other metal, metal alloy, or rigid material

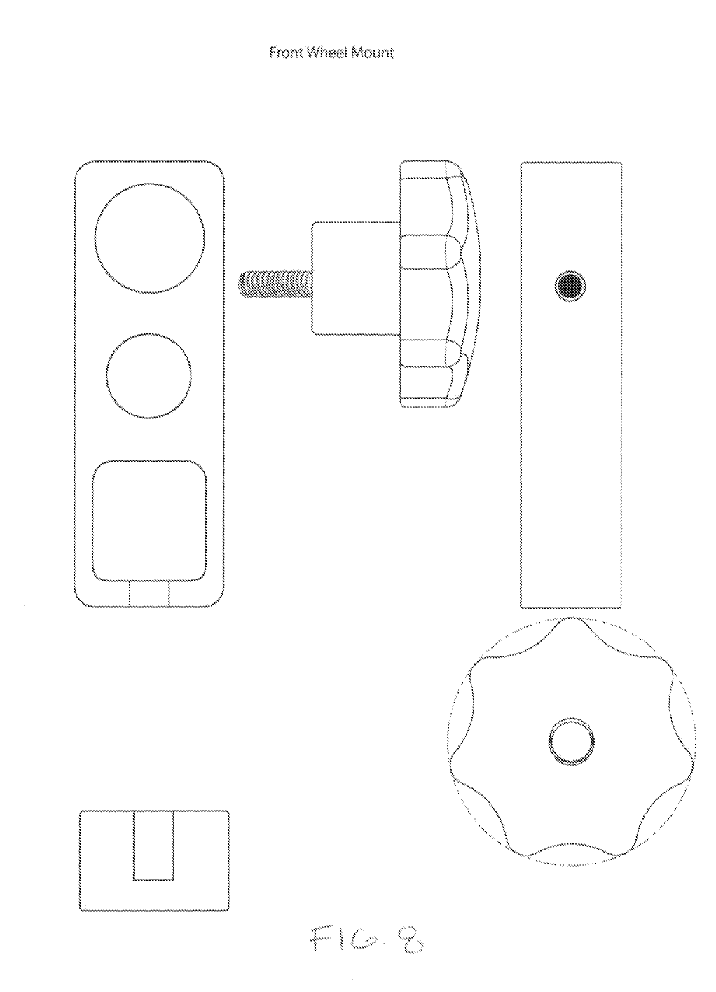

In one embodiment, as shown in FIG. 9, the bicycle wheel mount may include an “L” shaped component. Similar to the embodiment described above, the embodiment of FIG. 9 may include a square or rectangular-shaped opening or recess together with a square or rectangular-shaped slot to which the axle of a bicycle tire may be secured. On an “L” shaped component, where two sides of the component form a 90° angle, the slot may be located on one side of the component, and the recess or opening may be located on the perpendicular surface. The slot and opening or recess may be positioned so that they intersect or join at the 90° corner of the “L” shaped component. In other embodiments, the opening or recess and the slot may be shaped and located in any other arrangement in order to receive a bicycle tire axle. The bicycle wheel mount may have holes or openings through which screws, bolts, or other fastening devices may be placed to attach the wheel mount to the bicycle.

In one embodiment of the present disclosure, as shown in FIG. 1, two horizontal mounting bars may be placed on the roof or rear of a vehicle. Each horizontal mounting bar may be attached to the vehicle through the use of one vertical tower and attachment device at each end of each mounting bar.

The towers may be positioned in pairs, such that the openings for the horizontal mounting bars line up in a substantially straight line for each pair of vertical towers. The horizontal mounting bars may then be assembled, and a bar may be passed through the openings of each pair of vertical towers. Use of shoulder bolts to connect coupling devices to vertical towers, may allow for varied placement of the vertical towers. Use of shoulder bolts may permit the horizontal mounting bars, when attached to the vertical towers, to pivot about the x-axis of the vertical towers. This may allow the vertical towers to be attached to the vehicle at different heights. Use of the shoulder bolts may also permit the rack of the present disclosure to be installed on a vehicle with a rounded or curved surface. That is, where the towers are placed on a rounded or curved surface, they may tend to tip outwardly extending generally radially away from the curved surface of the roof. When viewed from the front or the rear of the vehicle, the towers may tend to extend upwardly and outwardly, for example. The shoulder bolt connection of the coupling device may allow the coupling device to pivot about a horizontal axis extending along the length of the vehicle thereby allowing the opening of the coupling device to be arranged generally horizontally and allowing for aligned installation of the mounting bars.

Once a horizontal mounting bar is positioned through the openings of two vertical towers, the lock screw on each vertical tower may be tightened to hold the horizontal mounting bar in place.

Next, a safety strap loop may be placed on the portion of the mounting bar extending toward the outside of the vehicle from the coupling device on the tower. The safety strap holder may also be placed on each outer edge of each horizontal mounting bar, next to the vertical towers and securing the loop of the strap between the safety strap holder and the coupling device. The lock screw on each safety strap holder may be tightened so as to lock the safety strap holder in position on the horizontal mounting bar. The additional locking screw may also be tightened to lock one end of the safety strap in place on the safety strap holder. This latter locking screw may allow any slack in the safety strap to be taken up and then the locking screw can be secured. The opposite end of each safety strap may be placed between the nearest vehicle door and the vehicle body, such that each strap may be clamped between a vehicle door and the vehicle body.

The vertical towers may serve to hold the mounting bars away from the vehicle, so that objects can be placed on top of the mounting bars and tied to them for transportation without resting on the vehicle. Objects may be placed directly on top of and secured to the horizontal mounting bars, or accessories, such as a carrying basket or a cradle for a canoe, may be attached on top of the horizontal mounting bars to hold small or particular objects in place for transportation.

Bar connectors may be used to create a different rack configuration, adding stability or versatility. A bar connector may be placed in the center of two parallel horizontal mounting bars, permitting a third horizontal mounting bar to be placed perpendicular to the two parallel bars, thus creating an I-shaped rack. Alternatively, a bar connector may be placed at each end of two parallel horizontal mounting bars, permitting a third and fourth bar to be placed perpendicular to the first two parallel bars, thus creating a square-shaped or rectangular-shaped rack. Other configurations may be created through the use of bar connectors and multiple horizontal mounting bars.

After use, the rack may be disassembled. The lock screws on the safety strap holders may be loosed, and the safety straps and holders may be removed. The lock screws on each vertical tower may then be loosened so that the horizontal mounting bars may be removed. Each horizontal mounting bar may be disassembled into its multiple sections. If the vertical towers are temporarily attached using suction or vacuum cups or any other form of temporary attachment device, they may be removed from the vehicle as well. The entire rack system may be reassembled on a different vehicle or stored for later use.

The rack of the present disclosure is versatile in that it may be installed in various positions on various vehicle types. The use of shoulder bolts or other pivoting mechanisms between vertical towers and coupling devices may permit the coupling devices to pivot, which may allow for versatility in installation. The use of threading or another adjustment device to allow for adjusting the height of the vertical towers may add further versatility. The use of bar connectors may permit customization of the rack's size and shape. The ease with which the rack may be assembled and disassembled may add to its versatility and usefulness. The use of horizontal mounting bars that may be disassembled into small sections may also add to the usefulness of the rack by making storage and transportation of the disassembled system easy for the user.

In one embodiment of the present disclosure, horizontal mounting bars that are less than two feet long may be used. Such bars may be composed of carbon fiber. A rack with short, carbon fiber horizontal mounting bars may be easily transported, but maintains strength.

In one embodiment of the present disclosure, as shown in FIG. 14, a rack may be installed across the bed of a pickup truck. The vertical towers may be installed such that one vertical tower at the end of each horizontal mounting bar may be uninstalled, and each horizontal mounting bar may be pivoted 90° about its remaining stationary tower. The uninstalled vertical tower at the end of each bar may be reinstalled along the ledge of the pickup truck bed, substantially in line with the stationary tower at the opposite end of each horizontal mounting bar. In some embodiments, the horizontal mounting bars will pivot about the stationary vertical towers. In other embodiments, each horizontal mounting bar may be removed from the stationary tower and inserted into an opening in the stationary tower perpendicular to the first opening. In some embodiments, all vertical towers may remain stationary on the pickup truck, but may have perpendicular openings, such that each horizontal mounting bar may be uninstalled and reinstalled into the perpendicular openings, thus having the same effect as the pivoting horizontal mounting bars, but without the need to uninstall vertical towers.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A rack for securing objects for automotive transportation comprising:
at least one horizontal mounting bar;
at least two vertical towers, wherein each vertical tower includes a pivoting mechanism to allow for varied placement of the towers; and
attachment devices which attach the vertical towers to the automobile.

2. The rack of claim 1, wherein each horizontal mounting bar may be deconstructed into multiple sections.

3. A bicycle wheel mount for attaching a bicycle tire to the bicycle frame.
